(19) United States
(12) Patent Application Publication
(10) Pub. No.: US 2002/0029344 A1
(43) Pub. Date: Mar. 7, 2002

(54) System and method for decrypting encrypted computer program

(75) Inventor: Takuya Morishita, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/942,994

(22) Filed: Aug. 31, 2001

(30) Foreign Application Priority Data
Sep. 6, 2000 (JP) 2000-269460

(51) Int. Cl. H04L 9/32; G06F 11/30

(52) U.S. Cl. 713/187

(57) ABSTRACT

The present invention is a system for decrypting an encrypted computer program, comprising: a cipher key generator for generating a first cipher key from a first block of the encrypted computer program; a decipherer for decrypting a plurality of second blocks of the encrypted computer program with said first cipher key; a cipher key generator for generating a second cipher key from one of said plurality of second blocks; a high-speed decipherer for decrypting another of said plurality of second blocks with said second cipher key; an illegal operation detector for detecting whether or not the encrypted computer program is analyzed; and a device for decrypting a plurality of dummy blocks instead of said plurality of second blocks if it is detected that the encrypted computer program is analyzed.

### BACKGROUND OF THE INVENTION

1. Field of the Invention

The present invention relates to a system and method for decrypting an encrypted computer program. The present invention particularly relates to a system and method for decrypting a computer program which has been encrypted to prevent from being illegally altered.

2. Description of the Prior Art

As systems for decrypting a encrypted computer program, there has been known hitherto a system disclosed by JPA 2000-122861. As shown in FIG. 4, this system comprises a data processing equipment 3 operating under program control, and a file equipment 4.

The data processing equipment 3 comprises a non-encrypted block reader 31, a cipher key generator 32, an encrypted block reader 33 and a decipherer 34. The file equipment 4 comprises non-encrypted block storage 41 and encrypted block storage 42.

In this system, the non-encrypted block storage 41 stores a non-encrypted block of a computer program. The encrypted block storage 42 separately stores encrypted blocks #1 to #n of the computer program, respectively. It is assumed herein that these blocks are read by the data processing equipment 3 in the order from the non-encrypted block to the encrypted blocks #1 to #n.

The non-encrypted block reader 31 reads non-encrypted block from the non-encrypted block storage 41 into a main memory which is not shown. The cipher key generator 32 applies a one-way function (e.g., a Hash function) to the computer program in this main memory to generate a cipher key for decrypting the encrypted blocks into plain blocks.

The encrypted block reader 33 reads encrypted blocks from the encrypted block storage 42 into a main memory. The decipherer 34 uses a cipher key generated by the cipher key generator 32 to decrypt the encrypted blocks.

The conventional system as mentioned above, however, has the following disadvantages. An execution speed for executing an encrypted computer program is slow as compared with a speed for executing a non-encrypted computer program, because the above-mentioned computer program decryption processing is repeatedly carried out.

Also, because no countermeasures are taken against means for analyzing a computer program, such as a software debugger, while executing the computer program, there is a possibility that a user illegally acquires a cipher key to be used to decipher the computer program.

### SUMMARY OF THE INVENTION

It is, therefore, an object of the present invention to provide a system and method capable of overcoming the above-mentioned disadvantages and executing an encrypted computer program at high speed.

It is another object of the present invention to provide a system and method capable of decreasing a possibility that a user illegally acquires a cipher key to be used to decipher a computer program.

According to the present invention, there is provided a system for decrypting an encrypted computer program, comprising: means for generating a first cipher key from a first block of the encrypted computer program; means for decrypting a plurality of second blocks of the encrypted computer program with the first cipher key; means for generating a second cipher key from one of the plurality of second blocks; and means for decrypting another of the plurality of second blocks with the second cipher key.

In the system, the first block may not be encrypted.

In the system, the plurality of second blocks may be encrypted at least with the first cipher key before treaded by this system.

In the system, at least one of the plurality of second blocks may be encrypted with the second cipher key before treated by this system.

The system may further comprise: means for detecting whether or not the encrypted computer program is analyzed; and means for decrypting a plurality of dummy blocks instead of the plurality of second blocks if it is detected that the encrypted computer program is analyzed.

### BRIEF DESCRIPTION OF THE DRAWINGS

FIG. 1 is a block diagram showing the constitution of a system for decrypting an encrypted computer program according to one embodiment of the present invention;

FIG. 2 is a flow chart showing the operation of the system as shown in FIG. 1 at the time of initialization;

FIG. 3 is a flow chart showing the operation of the system as shown in FIG. 1 at the time of execution; and

FIG. 4 is a block diagram showing the constitution of a conventional system for decrypting an encrypted computer program.

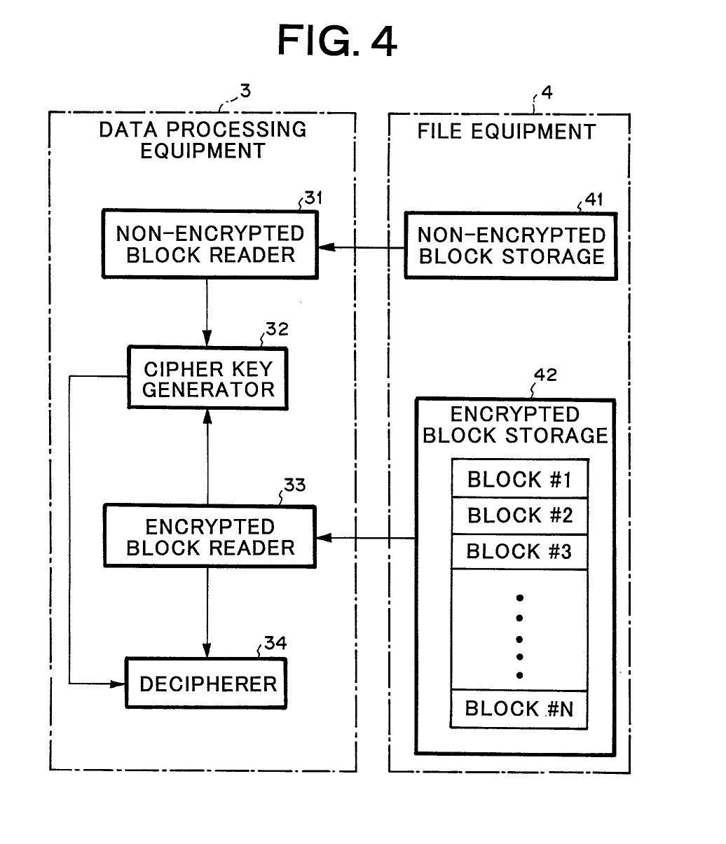

### DESCRIPTION OF THE EMBODIMENTS OF THE INVENTION

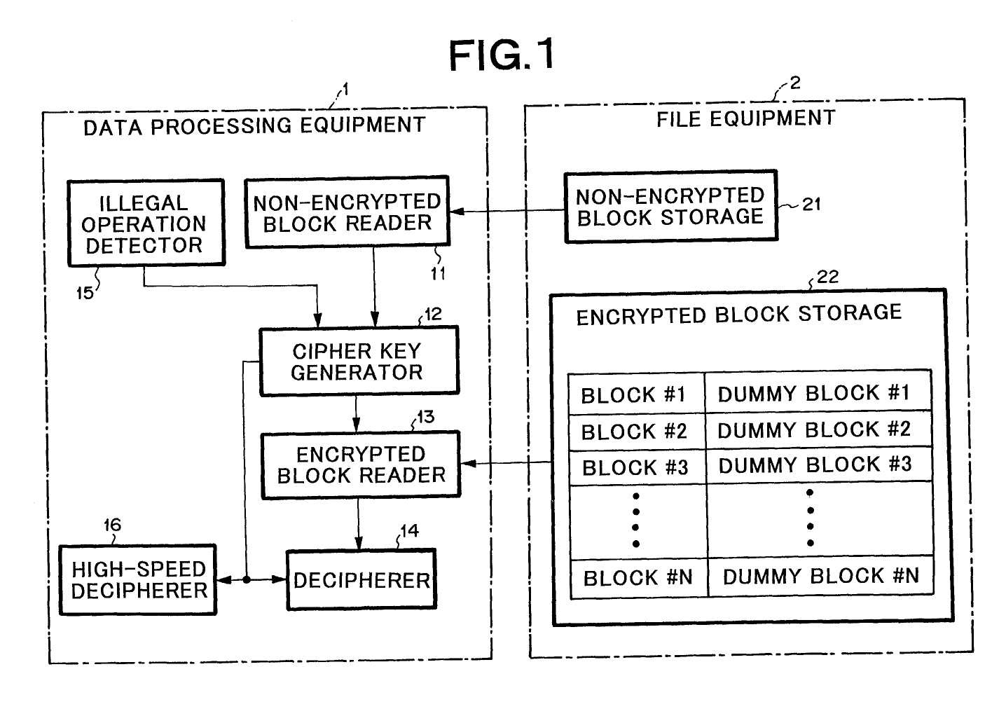

One embodiment of the present invention will be described hereinafter with reference to the drawings. FIG. 1 is a block diagram showing the constitution of the system for decrypting an encrypted computer program in the embodiment of the present invention. In FIG. 1, the system comprises a data processing equipment 1 operating under program control and a file equipment 2.

The data processing equipment 1 comprises a non-encrypted block reader 11, a cipher key generator 12, an encrypted block reader 13, a decipherer 14, an illegal operation detector 15, and a high-speed decipherer 16. The file equipment 2 comprises a non-encrypted block storage 21 and a encrypted block storage 22.

In the file equipment 2, the non-encrypted block storage 21 stores a non-encrypted block of a computer program. The encrypted block storage 22 separately stores encrypted blocks #1 to #n of the computer program. It is assumed that these blocks are read by the data processing equipment 1 in the order from the non-encrypted block to the encrypted blocks #1 to #n.

In addition, each of the blocks #2 to #n in the encrypted block storage 22 is encrypted by a cipher key which is generated from the preceding block. That is, the block #2 is encrypted by a cipher key which is generated from the block #1, the block #3 is encrypted by a cipher key which is generated from the block #2, and so forth. Further, all the blocks #1 to #n in encrypted block storage 22 are encrypted by a cipher key which is generated from the non-encrypted block 21.

The encrypted block storage 22 also stores encrypted dummy blocks #1 to #n. Each of the encrypted dummy blocks comprises codes which have no functions.

The non-encrypted block reader 11 reads a non-encrypted block from the non-encrypted block storage 21 into a main memory which is not shown. The cipher key generator 12 applies a one-way function (e.g., a Hash function) to the non-encrypted block in the main memory to generate a cipher key for decrypting the encrypted blocks #1 to #n into plain blocks.

Next, the encrypted block reader 13 reads the encrypted blocks #1 to #n from the encrypted block storage 22 into the main memory. The decipherer 14 uses the cipher key calculated by the cipher key generator 12 to decrypts the encrypted blocks #1 to #n.

The illegal operation detector 15 detects whether or not the operation of the computer program is analyzed by a software debugger or the like. The high-speed decipherer 16 uses a cipher key calculated by the cipher key generator 12 as in the case of the decipherer 14 to successively decrypt the encrypted blocks The high-speed decipherer 16 executes decryption at a higher speed than the decipherer 14.

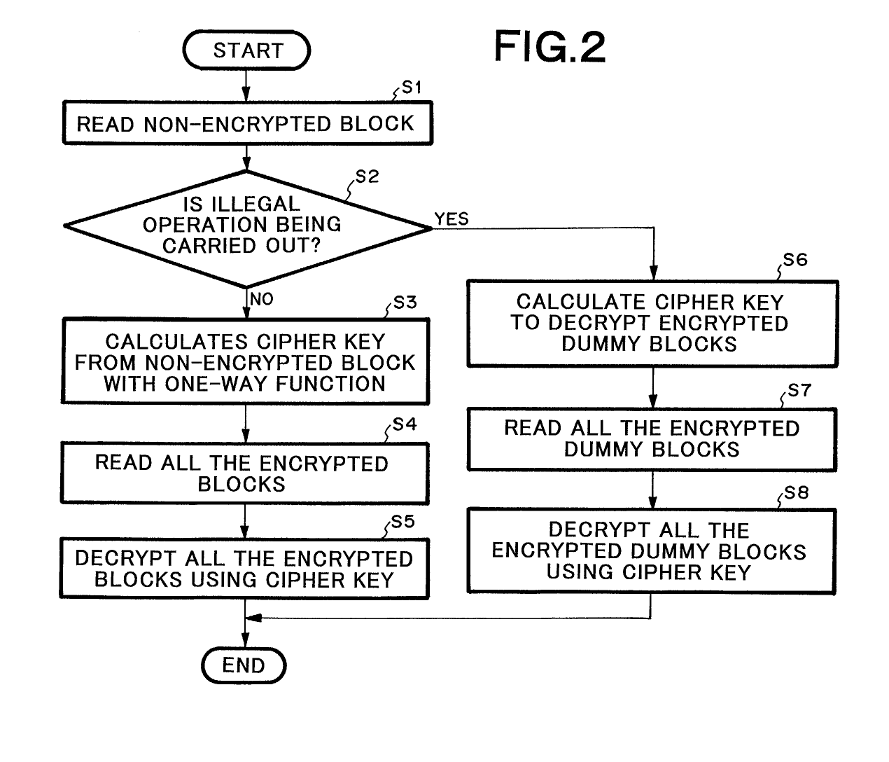

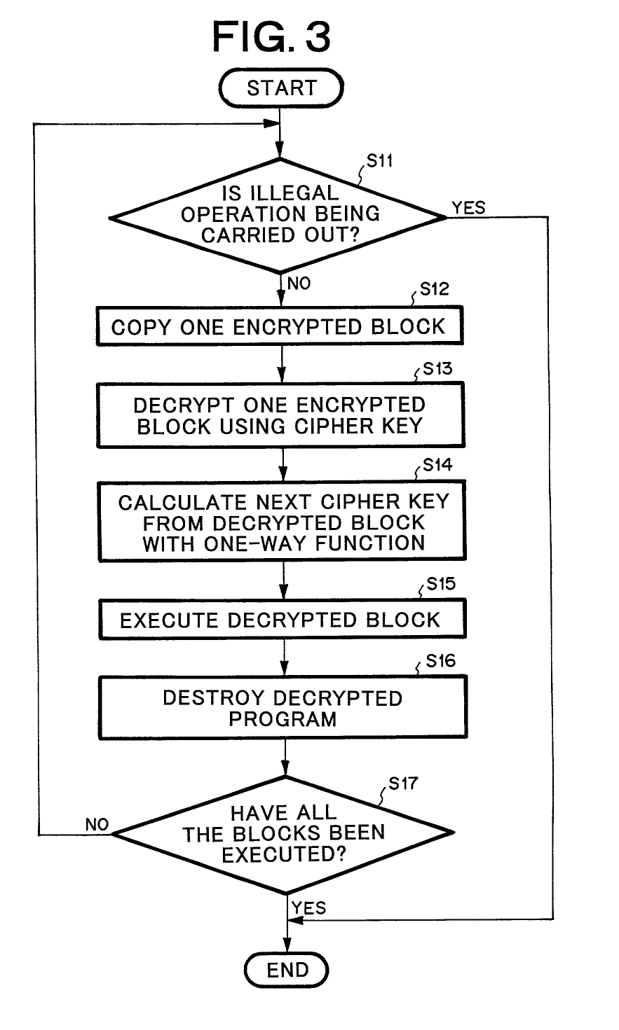

FIG. 2 is a flow chart showing the operation of the system during initialization. FIG. 3 is a flow chart showing the operation of the system during execution. Referring to FIGS. 1 to 3, the overall operation of the system will be described. It is noted that the operations as shown in FIGS. 2 and 3 are realized when the data processing equipment 1 reads and executes a control program stored in the main memory after transferring the control program from the external storage to the main memory. The external storage is such as a hard drive. Alternatively, the control program may be stored in a ROM as a part of the main memory, and directly read by the data processing equipment 1 when executed.

The operations of the system are broadly divided into the operation during initialization and the operation during execution. The operation during initialization is illustrated by FIG. 2 and the operation during execution is illustrated by FIG. 3. Although the operation during initialization is executed only once, the operation during execution is executed whenever it is necessary to execute an encrypted block.

First, during the initialization of the data processing equipment 1, the non-encrypted block reader 11 reads the non-encrypted block from the non-encrypted block storage 21 into the main memory and starts executing the non-encrypted block (at step S1 in FIG. 2). This processing is normally managed by a program executing mechanism (not shown) in an operating system.

The illegal operation detector 15 detects whether or not the operation of the computer program is analyzed by a software debugger or the like (at step S2 in FIG. 2). If no illegal operation such as operation analysis is carried out, the cipher key calculation means 102 applies a one-way function such as a Hash function to the non-encrypted block to generate a cipher key (at step S3 in FIG. 2).

The encrypted block reader 13 reads all the blocks #1 to #n from the encrypted block storage 22 into the main memory (at step S4 in FIG. 2). The decipherer 14 uses the cipher key calculated at step S3 to decrypt all the encrypted blocks #1 to #n (at step S5 in FIG. 2). At this stage, however, the blocks #2 to #n are still partly encrypted and it is necessary for the high-speed decipherer 16 to additionally decrypt the blocks #2 to #n. The processing during initialization in the case of no illegal operation is carried out is completed here.

If an illegal operation is carried out, the cipher key generator 12 applies a one-way function such as a Hash function to the non-encrypted block to generate a cipher key for decrypting the encrypted dummy blocks (at step S6 in FIG. 2).

The encrypted block reader 13 reads all the encrypted dummy blocks #1 to #n from the encrypted block storage 22 into the main memory (at step S7 in FIG. 2). The decipherer 14 uses the cipher key calculated at step S7 to decrypt the encrypted dummy blocks #1 to #n (at step S8 in FIG. 2). At this stage, however, the dummy blocks #2 to #n are still partly encrypted and it is necessary for the high-speed decipherer 16 to additionally decrypt the dummy blocks #2 to #n, The processing during initialization in the case of the illegal operation is carried out is completed here.

Next, the operation during execution will be described below.

During the execution of the data processing equipment 1, the illegal operation detector 15 detects whether or not the operation of a computer program is analyzed by a software debugger or the like (at step S11 in FIG. 3). The data processing equipment 1 ends the processing during execution if an illegal operation is carried out (if YES at step S11).

If no illegal operation such as operation analysis is carried out (if NO at step S11), the high-speed decipherer 16 copies a block #i (i=1, 2, . . . , n) to the main memory (at step S12 in FIG. 3). The high-speed decipherer 16 applies the cipher key which has been generated at step S14 in the preceding loop to the copied block in order to decrypt the copied block (at step S13 in FIG. 3). At this time, the blocks #2 to #n are completely decrypted. However, step S13 is skipped for block #1, because block #1 has been completely decrypted since step S5.

At step S13, the high-speed decipherer 16 executes decryption at a higher speed than the decipherer 14. High-speed decryption can be easily realized by, for example, shortening a cipher key length or reducing the number of rounds. Here, the weakened security by shortening the cipher key or the like is compensated by the above-mentioned whole encryption of the blocks #1 to #n.

The cipher key generator 12 calculates a Hash value of the completely decrypted block #i (i=1, 2, . . . , n) (at step S14). The Hash value will be used as a cipher key for decrypting the next block #(i+1) at the next loop. Thereafter, the data processing equipment 1 executes the completely decrypted block in the main memory (at step S15 in FIG. 3). During this processing, a determination as to illegal copy and the like are carried out.

Next, the data processing equipment 1 destroys the block executed at step S15 (at step S16 in FIG. 3). Next, the data processing equipment 1 determines whether or not steps S11 to S16 have been carried out for blocks #1 to #n (at step S17 in FIG. 3). If YES at step S17, the processing is completed. If no at step S17, the operation returns to the step S1 and the processing will be continued.

As can be seen from the above, the encryption processing is divided into the initialization processing executed only once and the execution processing executed a plurality of times, and a high-speed decryption algorithm is used for the latter processing, whereby the encrypted blocks can be executed at high speed.

Further, when a device, such as a software debugger, for analyzing the operation of a computer program while executing the computer program is detected, the operation of the computer program is changed. By doing so, it is possible to make it difficult to acquire a correct cipher key and, therefore, to decrease a probability that a user illegally acquires a cipher key to be used to decrypt the computer program.

What is claimed is:

1. A system for decrypting an encrypted computer program, comprising:
means for generating a first cipher key from a first block of the encrypted computer program;
means for decrypting a plurality of second blocks of the encrypted computer program with said first cipher key;
means for generating a second cipher key from one of said plurality of second blocks; and
means for decrypting another of said plurality of second blocks with said second cipher key.

2. The system as set forth in claim 1,
wherein said first block is not encrypted.

3. The system as set forth in claim 1,
wherein said plurality of second blocks are encrypted at least with said first cipher key before treaded by this system.

4. The system as set forth in claim 3,
wherein at least one of said plurality of second blocks is encrypted with said second cipher key before treated by this system.

5. The system as set forth in claim 1, further comprising:
means for detecting whether or not the encrypted computer program is analyzed; and
means for decrypting a plurality of dummy blocks instead of said plurality of second blocks if it is detected that the encrypted computer program is analyzed.

6. A method for decrypting an encrypted computer program, comprising the steps of:
generating a first cipher key from a first block of the encrypted computer program;
decrypting a plurality of second blocks of the encrypted computer program with said first cipher key;
generating a second cipher key from one of said plurality of second blocks; and
decrypting another of said plurality of second blocks with said second cipher key.

7. The method as set forth in claim 6,
wherein said first block is not encrypted.

8. The method as set forth in claim 6,
wherein said plurality of second blocks are encrypted at least with said first cipher key before treaded by this method.

9. The method as set forth in claim 8,
wherein at least one of said plurality of second blocks is encrypted with said second cipher key before treated by this method.

10. The method as set forth in claim 6, further comprising the steps of:
detecting whether or not the encrypted computer program is analyzed; and
decrypting a plurality of dummy blocks instead of said plurality of second blocks if it is detected that the encrypted computer program is analyzed.

11. A computer program product embodied on a computer-readable medium and comprising code that, when executed, causes a computer to perform a method for decrypting an encrypted computer program, said method comprising the steps of:
generating a first cipher key from a first block of the encrypted computer program;
decrypting a plurality of second blocks of the encrypted computer program with said first cipher key;
generating a second cipher key from one of said plurality of second blocks; and
decrypting another of said plurality of second blocks with said second cipher key.

12. The computer program product as set forth in claim 11,
wherein said first block is not encrypted.

13. The computer program product as set forth in claim 11,
wherein said plurality of second blocks are encrypted at least with said first cipher key before treaded by this method.

14. The computer program product as set forth in claim 13,
wherein at least one of said plurality of second blocks is encrypted with said second cipher key before treated by this method.

15. The computer program product as set forth in claim 11, wherein said method further comprises the steps of:
detecting whether or not the encrypted computer program is analyzed; and
decrypting a plurality of dummy blocks instead of said plurality of second blocks if it is detected that the encrypted computer program is analyzed.

16. A data structure embodied on a computer-readable medium comprising:
a non-encrypted block; and
a plurality of encrypted blocks;
wherein said plurality of encrypted blocks are encrypted with a cipher key generated from said non-encrypted block, and
wherein one of said plurality of encrypted blocks is encrypted with a cipher key generated from another of said plurality of encrypted blocks.
